(19) United States
(12) Patent Application Publication
(10) Pub. No.: US 2005/0226345 A1
(43) Pub. Date: Oct. 13, 2005

(54) Apparatus for reducing channel interference between proximate wireless communication units

(75) Inventors: Gerard Klahn, Sayville, NY (US); Robert Troiano, Farmingdale, NY (US); Fryderyk Tyra, Huntington Station, NY (US); Timothy A. Axness, Collegeville, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/085,695

(22) Filed: Mar. 21, 2005

Related U.S. Application Data
(60) Provisional application No. 60/557,931, filed on Mar. 31, 2004.

(51) Int. Cl. H04B 1/38

(52) U.S. Cl. 375/295

(57) ABSTRACT

Apparatus for reducing adjacent channel interference between proximate wireless communication units. Each wireless communication unit includes a digital baseband circuit and an analog baseband circuit. The digital baseband circuit includes at least one group delay compensation equalizer and at least one finite-impulse response (FIR) filter. The analog baseband circuit includes a radio (transmitter section), a power amplifier and a narrowband filter. The narrowband filter compensates for deficiencies of the power amplifier including distortion and radio frequency (RF) power spill over. The group delay compensation filter compensates for undesired characteristics (e.g., group delay variation) exhibited by the narrowband filter.

### CROSS REFERENCE TO RELATED APPLICATION

This application claims the benefit of U.S. Provisional Application No. 60/557,931 filed Mar. 31, 2004, which is incorporated by reference as if fully set forth.

### FIELD OF INVENTION

The present invention is related to a wireless communication including a plurality of wireless communication units, (i.e., mobile stations, base stations or the like). More particularly, the present invention is related to apparatus for reducing channel interference between those wireless communication units that are proximate to one another.

### BACKGROUND

Conventional wireless communication systems include a plurality of wireless communication units which communicate over a wireless medium. Such wireless communication units may include wireless transmit/receive units (WTRUs), (i.e., mobile stations), base stations, or the like. When two or more wireless communication units are proximate to one another while operating on frequency bands that are adjacent or separated by only a few channel bandwidths, a problem known as “adjacent channel interference” occurs. The receiver of one wireless communication unit may be interference limited by the spectral emissions of the transmitter in another proximate wireless communication unit, unless the transmitted spectral content is sufficiently suppressed so as not to effect the reception of the adjacent operator. Interference mitigation is required but is not always practical.

FIG. 1A shows an ideal output spectrum generated by multiple wireless communication units operating in adjacent bands. FIG. 1B shows a realistic scenario output spectrum of multiple wireless communication units operating in adjacent bands. In the ideal output spectrum of FIG. 1A, there is no spectral energy leaking into the adjacent bands. In the realistic output spectrum of FIG. 1B, spectral energy leaks into the adjacent bands due to the non-linearities in the transmitter of the wireless communication units, mostly due to a power amplifier (PA) therein. These non-linearities cause the spectral re-growth in the adjacent bands, thus limiting the frequency spacing between the wireless communication units.

The adjacent channel interference problem can be minimized with the use of linearized radio frequency (RF) PAs. Various known types of distortion correction techniques may be used in conjunction with the PAs to reduce the non-linearities and minimize the spectral re-growth into the adjacent channels. However, these corrected PAs have some disadvantages because the corrected PAs tend to be very expensive, are highly unstable over long periods, have poor power added efficiency, and the performance of the spectral re-growth correction is degraded with pulsed signals. Furthermore, such corrected PAs almost always need to be custom built. The linearized PAs also have limited spectral re-growth correction capability, which is less than what the Universal Mobile Telecommunications System (UMTS) specifications require.

In the conventional wireless communication systems, different types of amplifiers are used to provide reduced interference levels, such as feed forward amplification systems, adaptive or non-adaptive pre-distortion amplification systems, feedback amplification systems, and large, oversized Class A power amplifiers. However, such amplifiers pose undesired distortion and power spill over characteristics.

A method and apparatus for reducing channel interference between proximate wireless communication units and eliminating the above-mentioned undesirable characteristics of power amplifiers is desired.

### SUMMARY

The present invention is related to apparatus for reducing adjacent channel interference between proximate wireless communication units. Each wireless communication unit includes a digital baseband circuit and an analog baseband circuit. The digital baseband circuit includes at least one group delay compensation equalizer and at least one finite-impulse response (FIR) filter. The analog baseband circuit includes a radio (transmitter section), a power amplifier and a narrowband filter. The narrowband filter compensates for deficiencies of the power amplifier including distortion and radio frequency (RF) power spill over. The group delay compensation filter compensates for undesired characteristics (e.g., group delay variation) exhibited by the narrowband filter.

### BRIEF DESCRIPTION OF THE DRAWING(S)

A more detailed understanding of the invention may be had from the following description of a preferred embodiment, given by way of example and to be understood in conjunction with the accompanying drawing wherein:

FIG. 1A shows an ideal output spectrum generated by multiple wireless communication units operating in adjacent bands;

FIG. 1B shows a realistic scenario output spectrum of multiple wireless communication units operating in adjacent bands;

FIG. 2 shows a block diagram of a wireless communication unit configured to reduce adjacent channel interference in accordance with the present invention; and

FIG. 3 shows an example of a group delay compensation equalizer used in the wireless communication unit of FIG. 2.

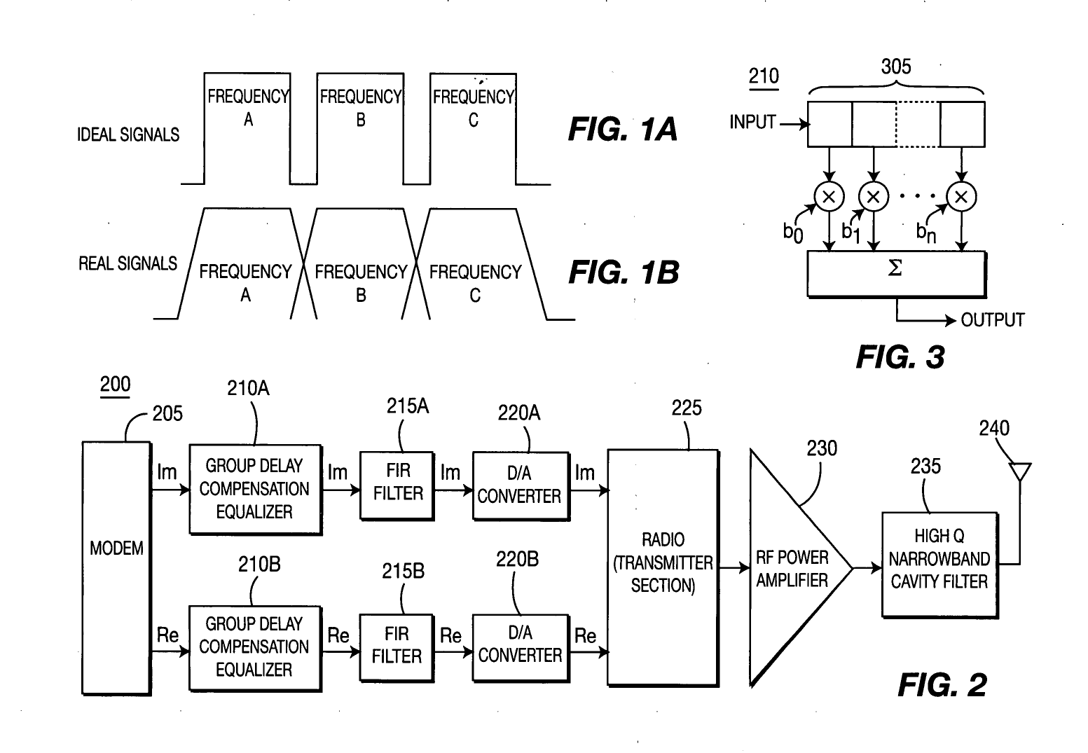

### DETAILED DESCRIPTION OF THE PREFERRED EMBODIMENT(S)

Although the features and elements of the present invention are described in the preferred embodiments in particular combinations, each feature or element can be used alone (without the other features and elements of the preferred embodiments) or in various combinations with or without other features and elements of the present invention.

The present invention is applicable to any type of conventional wireless communication system including systems using time division duplex (TDD), frequency division duplex (FDD), code division multiple access (CDMA), CDMA 2000, time division synchronous CDMA (TDSCDMA), orthogonal frequency division multiplexing (OFDM) or the like.

Hereafter, the terminology “wireless communication unit” includes but is not limited to a wireless transmit/receive unit (WTRU), a user equipment (UE), a mobile station, a fixed or mobile subscriber unit, a pager, a base station, a Node-B, a site controller, an access point or any other type of interfacing device capable of operating in a wireless environment.

The features of the present invention may be incorporated into an integrated circuit (IC) or be configured in a circuit comprising a multitude of interconnecting components.

The present invention is related to a wireless communication unit configuration which yields a significantly lower distortion and RF power spill over. FIG. 2 shows a block diagram of a wireless communication unit 200 configured to reduce adjacent channel interference in accordance with the present invention. The wireless communication unit 200 includes a modem 205 which outputs in-phase (I or real or “Re”) and quadrature (Q or imaginary or “Im”) signal components, group delay compensation equalizers 210A and 210B, finite-impulse response (FIR) filters 215A and 215B, digital to analog (D/A) converters 220A and 220B, a radio (transmitter section) 225, an RF PA 230, a high quality (“Q”) narrowband cavity filter 235 and an antenna 240. The modem 205 contains the baseband processing used to generate digital baseband chips or symbols in the wireless communication unit 200. The group delay compensation equalizers 210A, 210B correct the very large group delay variations caused by the high Q narrowband cavity filter 235. This will allow compliance to UMTS TDD based wireless communication units with regard to co-location or same geography specifications.

Both of the equalizers 210A and 210B may be configured as a FIR filter. Alternatively, both of the equalizers 210A and 210B may be configured as an infinite impulse response (IIR) filter implementation.

Both of the equalizers 210A and 210B and the FIR filters 215A and 215B include tapped delay lines. The FIR filters 215 shape the chips generated by the modem 205. The FIR filters may be root-raised cosine (RRC) filters. The D/A converters convert the digital baseband signal into an analog baseband signal, which the radio 225 then modulates onto a carrier.

The wireless communication unit of FIG. 2 includes a transmitter which incorporates group delay equalization in the baseband portion of the transmitter and a high Q narrowband cavity filter 235 in the RF portion of the transmitter. These components in concert provide high adjacent channel leakage rejection (ACLR) and alternate channel rejection in all transmit applications requiring high adjacent and alternate channel leakage rejection levels.

In an exemplary application for UMTS TDD, the pass band of the cavity filter 235 is 5 MHz, although this technique may be extended to other standards. The high Q narrowband cavity filter 235 provides the high leakage rejection in adjacent and alternate channels at the expense of creating large group delay variation within the bandwidth of interest. This large group delay variation degrades the signal integrity of the received signal at the receiving end of the communication system, thus making this technique undesirable unless the group delay variation is compensated for. The group delay compensation equalizers 210A, 210B reduce the group delay variation caused by the high Q narrowband cavity filter 235 by convolving a group delay characteristic which is the inverse of the group delay characteristic of the high Q narrowband cavity filter 235. This results in a semi-flat group delay response across the band of interest, thus allowing for the use of the high Q narrowband cavity filter 235 to achieve high adjacent channel leakage rejection.

Table 1 below provides some examples of mixing various types of basic class A linear PAs, linearized PAs that use either feed forward, feed back, or pre-distortion type linearization techniques, and high Q narrowband cavity filters together. Table 1 describes the adjacent channel leakage rejection requirements throughout the transmitter path. The input ACLR occurs at the input of the D/A converters 220A and 220B. Columns five (Lin PA ACLR Impr) and six (Filter ACLR Impr) describe the ACLR improvement of the linearized PA and the high Q narrowband filter, respectively. Column seven (Total ACLR) provides the total accumulated ACLR of the transmitter path.

TABLE 1
Power Amplifier and High Q Narrowband Cavity Filter Configurations

| | | | | | | |
|---|---|---|---|---|---|---|
| | D/A | | | | | |
| Input | Conv | Transmitter | PA | Lin PA | Filter | Total |
| ACLR | SNR | ACLR | ACLR | ACLR Impr | ACLR Impr | ACLR |

Linear PA

| | | | | | | | |
|---|---|---|---|---|---|---|---|
| Case 1 | −70 dBc | −80 dBc | −75 dBc | −45 dBc | 20 dB | 0 dB | −63 dBc |

PA with 4 section cavity filter

| | | | | | | | |
|---|---|---|---|---|---|---|---|
| Case II | −60 dBc | −80 dBc | −50 dBc | −45 dBc | 0 dB | 21 dB | −65 dBc |

PA with 8 section cavity filter

| | | | | | | | |
|---|---|---|---|---|---|---|---|
| Case III | −60 dBc | −80 dBc | −50 dBc | −45 dBc | 0 dB | 58 dB | −102 dBc |

Linearized PA with 4 section cavity filter

| | | | | | | | |
|---|---|---|---|---|---|---|---|
| Case IV | −70 dBc | −80 dBc | −75 dBc | −45 dBc | 20 dB | 21 dB | −84 dBc |

Linearized PA with 8 section cavity filter

| | | | | | | | |
|---|---|---|---|---|---|---|---|
| Case V | −70 dBc | −80 dBc | −75 dBc | −45 dBc | 20 dB | 58 dB | −121 dBc |

Case I of Table 1 shows the ACLR improvement with using only a linearized power amplifier.

Case II of Table 1 shows that by using a four section high Q narrowband cavity filter, the same ACLR can be achieved while relaxing the requirements of the transmitter path before the PA stage and the input ACLR into the D/A converters, while using a basic class A power amplifier.

Case III of Table 1 is similar to case II except that an eight section high Q narrowband cavity filter is used.

Cases IV and V of Table 1 are high ACLR configurations using a linearized PA with four and eight section high Q narrowband cavity filters, respectively.

FIG. 3 shows an example of how the group delay compensation equalizers 210A and 210B used in the wireless communication unit of FIG. 2 are configured. Each of the equalizers 210 include a tapped delay line 305 that is weighted by a plurality of coefficients b₀, b₁, . . . , bₙ, such that the combined group delay of the equalizers 210 and the narrowband cavity filter 235 exhibit minimal residual group delay variation, (i.e., ripple). The target response used in generating the coefficients of the equalizers 210 is the inverse of the group delay variation of the narrowband cavity filter 235. There are several ways to generate the coefficients based on the target response, which extend beyond the scope of the present invention.

In one embodiment, the group delay compensation filter 210A and the FIR filter 215A may be combined into a first single unit, and the group delay compensation filter 210B and the FIR filter 215B may be combined into a second single unit. Thus, the coefficients of the equalizers 210 are convolved with the FIR filters 215 in each respective combination to produce a large number of coefficients that carry out the functions of both the equalizers 210 and filters 215.

In another embodiment, a corrected or linearized RF PA is used instead of a standard RF Power Amplifier. This embodiment of the present invention will obtain increased performance. In the some scenarios, a commercially purchased corrected power amplifier can produce an improvement of 25 to 30 dB for adjacent channel power emissions over a non-corrected amplifier of the same size. Using the apparatus in this invention instead of a commercially purchased corrected amplifier, 60 to 80 dB of improvement is possible for less than the cost of the corrected amplifier approach. This gain in performance can be achieved without incurring additional distortion that large group delay variations would otherwise create. There are some TDD/FDD co-location scenarios which need to implement the present invention in order to be fully compliant with UMTS specifications.

Although the features and elements of the present invention are described in the preferred embodiments in particular combinations, each feature or element can be used alone (without the other features and elements of the preferred embodiments) or in various combinations with or without other features and elements of the present invention.

While specific embodiments of the present invention have been shown and described, many modifications and variations could be made by one skilled in the art without departing from the scope of the invention. The above description serves to illustrate and not limit the particular invention in any way.

1. A wireless communication unit comprising:
(a) a digital baseband circuit comprising at least one group delay compensation equalizer and at least one finite-impulse response (FIR) filter; and
(b) an analog baseband circuit comprising a radio, a power amplifier and a narrowband filter, wherein the narrowband filter compensates for deficiencies exhibited by the power amplifier, and the compensation filter compensates for undesirable characteristics exhibited by the narrowband filter.

2. The wireless communication unit of claim 1 wherein the narrowband filter is a high quality (Q) narrowband cavity filter which provides high adjacent channel leakage rejection in adjacent channels and creates a large group delay variation over a desired passband.

3. The wireless communication unit of claim 2 wherein the group delay compensation equalizer substantially reduces the group delay variation caused by the high Q narrowband cavity filter by convolving with an inverse of the group delay characteristic of the high Q narrowband cavity filter, resulting in a more desirable group delay response across the passband.

4. The wireless communication unit of claim 2 wherein the passband is 5 MHz.

5. The wireless communication unit of claim 1 further comprising at least one digital-to-analog (D/A) converter that connects the digital baseband circuit to the analog baseband circuit.

6. The wireless communication unit of claim 1 wherein the group delay compensation equalizer includes a tapped delay line weighted by a plurality of coefficients such that the output of the group delay compensation equalizer is substantially equivalent to the inverse of the group delay variation created by the narrowband cavity filter.

7. The wireless communication unit of claim 1 wherein the power amplifier is a class A linear power amplifier.

8. The wireless communication unit of claim 1 wherein the power amplifier is a linearized power amplifier that uses feed forward, feed back or predistortion type linearization techniques.

9. The wireless communication unit of claim 1 wherein the wireless communication unit is a base station.

10. The wireless communication unit of claim 1 wherein the wireless communication unit is a wireless transmit/receive unit (WTRU).

11. The wireless communication unit of claim 1 wherein the deficiencies of the power amplifier compensated for by the narrowband filter include distortion and radio frequency (RF) power spill over.

12. An integrated circuit (IC) comprising:
(a) a digital baseband circuit comprising at least one group delay compensation equalizer and at least one finite-impulse response (FIR) filter; and
(b) an analog baseband circuit comprising a radio, a power amplifier and a narrowband filter, wherein the narrowband filter compensates for deficiencies exhibited by the power amplifier, and the compensation filter compensates for undesirable characteristics exhibited by the narrowband filter.

13. The IC of claim 12 wherein the narrowband filter is a high quality (Q) narrowband cavity filter which provides high adjacent channel leakage rejection in adjacent channels and creates a large group delay variation over a desired passband.

14. The IC of claim 13 wherein the group delay compensation equalizer substantially reduces the group delay variation caused by the high Q narrowband cavity filter by convolving with an inverse of the group delay characteristic of the high Q narrowband cavity filter, resulting in a more desirable group delay response across the passband.

15. The IC of claim 13 wherein the passband is 5 MHz.

16. The IC of claim 12 further comprising at least one digital-to-analog (D/A) converter that connects the digital baseband circuit to the analog baseband circuit.

17. The IC of claim 12 wherein the group delay compensation equalizer includes a tapped delay line weighted by a plurality of coefficients such that the output of the group delay compensation equalizer is substantially equivalent to the inverse of the group delay variation created by the narrowband cavity filter.

18. The IC of claim 12 wherein the power amplifier is a class A linear power amplifier.

19. The IC of claim 12 wherein the power amplifier is a linearized power amplifier that uses feed forward, feed back or predistortion type linearization techniques.

20. The IC of claim 12 wherein the IC is comprised by a base station.

21. The IC of claim 12 wherein the IC is comprised by a wireless transmit/receive unit (WTRU).

22. The IC of claim 12 wherein the deficiencies of the power amplifier compensated for by the narrowband filter include distortion and radio frequency (RF) power spill over.
